(19) United States
(12) Patent Application Publication
(10) Pub. No.: US 2022/0334402 A1
(43) Pub. Date: Oct. 20, 2022

(54) APPARATUS FOR ASSEMBLING PRISM, AND PRODUCTION FACILITY

(71) Applicant: IVIEW DISPLAYS (SHENZHEN) COMPANY LTD., Shenzhen (CN)

(72) Inventors: Xiong Zhou, Shenzhen (CN); Liang Mei, Shenzhen (CN); Mingnei Ding, Shenzhen (CN); Steve Yeung, Hongkong (CN); Zhiqiang Gao, Hongkong (CN)

(21) Appl. No.: 17/739,245

(22) Filed: May 9, 2022

Related U.S. Application Data
(63) Continuation of application No. PCT/CN2021/100654, filed on Jun. 17, 2021.

(30) Foreign Application Priority Data
Apr. 14, 2021 (CN) 202110401989.7

(51) Int. Cl. G02B 27/62; B25J 15/06; B23P 21/00

(52) U.S. Cl. CPC G02B 27/62; B25J 15/0616; B23P 21/004

(57) ABSTRACT

Embodiments of the present disclosure relate to an apparatus for assembling a prism, and a production facility. The apparatus includes: a first station, configured for placement of the prism; a second station, configured for placement of a fitting body; a manipulator, configured to grasp the prism; a first drive unit, connected to the manipulator, and configured to drive the manipulator to be lifted or lowered; and a second drive unit, connected to the first drive unit, and configured to drive the first drive unit to reciprocate between the first station and the second station; a clamping device, disposed in the mounting slot of the fitting body, and configured to clamp the prism; and a controller, connected to the manipulator, the first drive unit, and the second drive unit.

### CROSS-REFERENCE TO RELATED APPLICATIONS

This application is a continuation-application of International (PCT) Patent Application No. PCT/CN2021/100654, filed on Jun. 17, 2021, which claims priority to Chinese Patent Application No. 202110401989.7, filed with the National Intellectual Property Administration of China on Apr. 14, 2021, and entitled “APPARATUS FOR ASSEMBLING PRISM, AND PRODUCTION FACILITY”, the entire contents of which are incorporated herein by reference.

### TECHNICAL FIELD

Embodiments of the present disclosure relate to the field of prism assembling technologies.

### BACKGROUND

A prism is an optical device which is made of a transparent material, and has a triangular cross section. In optical instruments, the prism is used to decompose composite light into spectrum or to change the direction of light rays, and is also called a triangular prism. During the use, the prism often needs to be assembled on a fitting body. In this way, the stability of the prism is maintained and thus the accuracy of the prism is ensured; and further, the prism is assembled to the fitting body, such that the prism may be effectively prevented from the friction or collision from an external object, and thus a normal function of the prism is effectively protected.

During practice of the present disclosure, the present inventors have found that: at present, the traditional process of assembling the prism to the fitting body is generally performed in a manual method. The manual assembling method has a low efficiency and a high product defect rate.

### SUMMARY

According to an embodiment of the present disclosure, an apparatus for assembling a prism is provided. The apparatus is configured to assemble the prism into a mounting slot of a fitting body. The apparatus includes: a first station, configured for placement of the prism; a second station, configured for placement of the fitting body; a manipulator, configured to grasp the prism; a first drive unit, connected to the manipulator, and configured to drive the manipulator to be lifted or lowered; and a second drive unit, connected to the first drive unit, and configured to drive the first drive unit to reciprocate between the first station and the second station; a clamping device, disposed in the mounting slot of the fitting body, and configured to clamp the prism; and a controller, connected to the manipulator, the first drive unit, and the second drive unit.

According to another embodiment of the present disclosure, an apparatus for assembling a prism is provided. The apparatus is configured to assemble the prism to a fitting body, and comprises: a first station, configured for placement of the prism; a second station, configured for placement of the fitting body; a manipulator, configured to grasp the prism; a first drive unit, connected to the manipulator, and configured to drive the manipulator to be lifted or lowered; a second drive unit, connected to the first drive unit, and configured to drive the first drive unit to reciprocate between the first station and the second station; and a clamping device, disposed on the fitting body, and configured to clamp the prism.

According to another embodiment of the present disclosure, a production facility is provided. The production facility includes the apparatus for assembling the prism as described above.

### BRIEF DESCRIPTION OF THE DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic diagram illustrating an apparatus for assembling a prism applied to prism assembling according to an embodiment of the present disclosure.

FIG. 2 is a diagram illustrating connections between parts of the apparatus for assembling the prism according to an embodiment of the present disclosure.

FIG. 3 is a schematic diagram illustrating a prism assembled to the fitting body according to an embodiment of the present disclosure.

FIG. 4 is a schematic diagram illustrating a manipulator, a first drive unit, and a second drive unit according to an embodiment of the present disclosure.

FIG. 5 is a schematic diagram illustrating a clamping device mounted in a mounting slot according to an embodiment of the present disclosure.

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical,” “horizontal,” “left,” “right,” “inner,” “outer,” and similar expressions are only for illustration purposes.

Unless the context clearly requires otherwise, throughout the specification and the claims, technical and scientific terms used herein denote the meaning as commonly understood by a person skilled in the art. Additionally, the terms used in the specification of the present disclosure are merely for describing the objects of the specific embodiments, and are not intended to limit the present disclosure. As used herein, the term “and/or” in reference to a list of one or more items covers all of the following interpretations of the term: any of the items in the list, all of the items in the list and any combination of the items in the list.

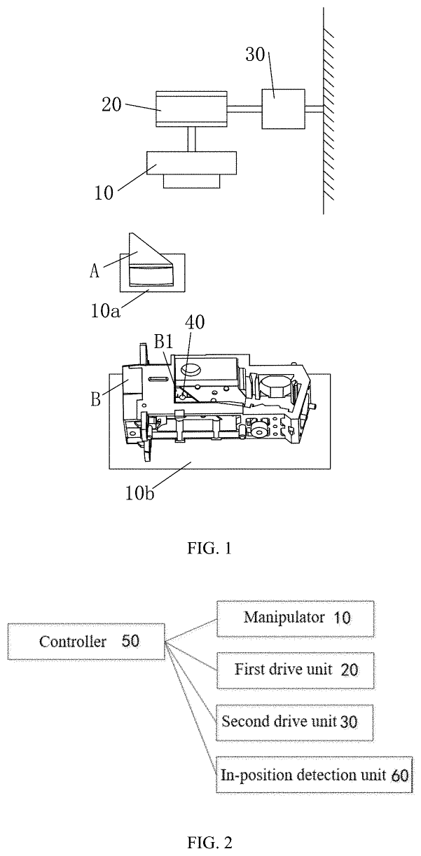

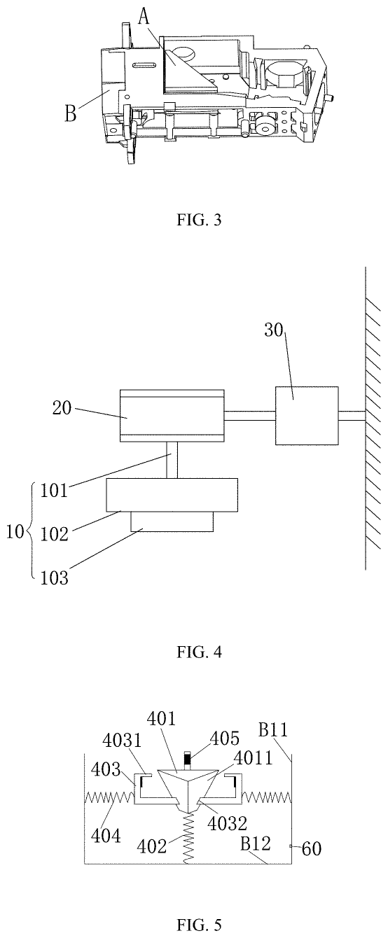

Referring to FIG. 1 to FIG. 3, an apparatus for assembling a prism A includes: a first station 10a, a second station 10b, a manipulator 10, a first drive unit 20, a second drive unit 30, a clamping device 40, and a controller 50. The first station 10a is configured for placement of the prism A. The second station 10b is configured for placement of the fitting body B. The manipulator 10 is configured to grasp the prism A. The first drive unit 20 is connected to the manipulator 10, and configured to drive the manipulator 10 to be lifted or lowered. The second drive unit 30 is connected to the first drive unit 20, and configured to drive the first drive unit 30 to reciprocate between the first station 10a and the second station 10b. The clamping device 40 is disposed in a mounting slot B1 of the fitting body, and configured to clamp the prism A. The controller 50 is connected to the manipulator 10, the first drive unit 20, and the second drive unit 30. The prism A is grasped by the manipulator 10, and the manipulator 10 moves the prism A to the fitting body B under the actions of the first drive unit 20 and the second drive unit 30 and releases the prism A, and the prism A is assembled to the clamping device 40 of the fitting body B. In this way, the manipulator 10 assembles the prism A to the fitting body B with no need of manual assembling, and the operation is convenient.

With respect to the first station 10a and the second station 10b, the first station 10a is configured for placement of the prism A, and the second station 10b is configured for placement of the fitting body B. In some embodiments, a predetermined distance is defined between the first station 10a and the second station 10b, that is, a distance between the prism A and the clamping device 40 which needs to clamp the prism A on the fitting body B is fixed, such that the manipulator 10 conveniently moves the prism A to the fitting body B and the clamping device 40 clamps the prism A.

With respect to the manipulator 10, in some embodiments, referring to FIG. 4, the manipulator 10 includes a connection arm 101, a vacuum generator 102, and a vacuum cup 103. One end of the connection arm 101 is connected to the first drive unit 20 and the other end of the connection arm 101 is connected to the vacuum generator 102, and the vacuum generator 102 is further connected to the vacuum cup. In response to the vacuum generator 102 being started, the vacuum cup 103 may suction the prism A; and in response to the vacuum generator 102 being stopped, the vacuum cup 103 may release the prism A.

It should be noted that, the vacuum generator 102 may be integrally formed, or designed separately, as long as the vacuum cup 103 is controllable under operation of the vacuum generator, such that the vacuum cup 103 may suction or release the prism A.

It should be noted that, in some embodiments, the vacuum cup 103 is made of rubber, such that in response to suctioning or releasing the prism A, the vacuum cup 103 may not scratch the prism A, thereby effectively ensuring optical performance of the prism A.

The first drive unit 20 is connected to the manipulator 10, and configured to drive the manipulator 10 to be lifted or lowered. The lift refers to going distally from the first station 10a along a first direction, wherein the first direction is perpendicular to a surface, distal from the first station 10a, of the prism A. The lower refers to going proximally to the first station 10a along the first direction.

It should be noted that, in some embodiments, the drive unit 20 includes a cylinder.

The second drive unit 30 is connected to the first drive unit 20, and configured to drive the first drive unit 20 to reciprocate between the first station 10a and the second station 10b. In the case that the first drive unit 20 reciprocates between the first station 10a and the second station 10b, the manipulator 10 connected to the first drive unit 20 and the prism A grasped by the manipulator 10 may reciprocate between the first station 10a and the second station 10b.

It should be noted that, in some embodiments, the second drive unit 30 includes a cylinder. The first station 10a, the second station 10b, and the second drive unit 30 are reasonably disposed, such that in the case that the second drive unit 30 includes the cylinder, the functions of the second drive unit 30 may be implemented.

It should be noted that, in some embodiments, the second drive unit 30 is fixed to a wall, a ground, or a ceiling.

Referring to FIG. 1 and FIG. 5, the clamping device 40 includes a carrier 401, a first elastic member 402, a clamping arm 403, a second elastic member 404, and a cushion member 405. The first elastic member 402 is disposed at a bottom B12 of the mounting slot B1; an end, distal from the fitting body B, of the first elastic member 402 is connected to the carrier 401; an end, distal from the first elastic member 402, of the carrier 401 is configured to carry the prism A, and the carrier 401 is movable relative to the fitting body B. The second elastic member 404 is disposed on a wall B11 of the mounting slot B1; an end, distal from the fitting body B, of the second elastic member 404 is connected to one end (or a first end) of the clamping arm 403; another end (or a second end) of the clamping arm 403 is abutted against the carrier 401, and still another end (or a third end) of the clamping arm 403 is configured to be abutted against the prism A, and the clamping arm 403 is movable relative to the fitting body B. By configuration of the clamping device 40, the clamping device 40 is configured to clamp the prism A, and in response to the prism A being assembled to the fitting body B, the prism A is not easily shaken with respect to the fitting body B, thereby ensuring the optical performance of the prism A.

In the embodiments of the present disclosure, the first drive unit 20 drives the manipulator 10 to be lowered, the prism A grasped by the manipulator 10 applies an action force against the carrier 401, the first elastic member 402 is compressed, the second elastic member 404 is compressed, the clamping arm 403 moves towards a direction away from the carrier 401, the manipulator 10 releases the prism A, the first elastic member 402 rebounds, the second elastic member 404 rebounds, the clamping arm 403 moves towards a direction close to the carrier 401, and the prism A is clamped between the clamping arm 403 and the mounting slot B1.

It should be noted that, in some embodiments, a size of a surface of the carrier 401 for contacting the prism A has a predetermined ratio with the prism A, thereby ensuring that the prism A is not easily damaged where the prism A applies an action force against the carrier 401.

It should be noted that, in some embodiments, a distance from an end, distal from the bottom B12 of the mounting slot B1, of the carrier 401 to the bottom B12 of the mounting slot B1 is not less than a distance from the still another end of the clamping arm 403 to the bottom B12 of the mounting slot B1, thereby causing the prism A to press the carrier 401.

It should be noted that, in some embodiments, three second elastic members 404 are configured, three clamping arms 403 are configured, the three second elastic members 404 are distributed on the wall B11 of the mounting slot B1; and an end, distal from the fitting body B, of one of the second elastic members 404 is connected to one end of the clamping arm 403, such that three clamping arms 403 may stably clamp the prism A.

It should be noted that, in some embodiments, still another end of the clamping arm 403 is bent towards the carrier 401 to form a hook 4031, wherein the hook 4031 is configured to be fitted to an end, distal from the carrier 401, of the prism A in response to the prism A being carried by the carrier 401, such that the clamping device 40 is caused to stably clamp the prism A.

It should be noted that, in some embodiments, the apparatus for assembling the prism A further includes an in-position detection unit 60, wherein the in-position detection unit 60 is disposed in the mounting slot B1 and connected to the controller 50, and the controller 50 controls, in response to detecting that the carrier 401 moves to a predetermined position by the in-position detection unit 60, the manipulator 10 to release the prism A grasped by the manipulator 10, such that the hook 4031 is abutted against the end, distal from the carrier 401, of the prism A.

The predetermined position refers to that, in response to the prism A pressing the carrier 401 to cause the carrier 401 to move to the predetermined position, the distance from an end, distal from the bottom B12 of the mounting slot B1, of the prism A to the bottom B12 of the mounting slot B1 is not greater than a distance from a surface towards the bottom B12 of the mounting slot B1, of the hook 4031 to the bottom B12 of the mounting slot B1.

It should be noted that, in some embodiments, the in-position detection unit 60 includes an infrared sensor.

Preferably, the in-position detection unit 60 is disposed on the wall B11 of the mounting slot B1.

It should be noted that, in some embodiments, the carrier 401 is provided with a first ramp 4011, wherein the first ramp 4011 is disposed to face the bottom B12 of the mounting slot B1; and the another end of the clamping arm 403 is provided with a second ramp 4032, wherein the second ramp 4032 is disposed to face the first ramp 4011, and the second ramp 4032 is abutted against the first ramp 4011.

It should be noted that, in some embodiments, where three clamping arms 403 are configured, three second ramps 4032 are configured, three first ramps 4011 are configured, and one of the three second ramps 4032 is abutted against one of three first ramps 4011.

It should be noted that, in some embodiments, the cushion member 405 is made of rubber.

It should be noted that, the cushion member 405 may not be provided, and the function of the clamping device 40 clamping the prism A may also be achieved. The cushion member 405 is provided, and the cushion member 405 is positioned between still another end of the clamping arm 403 and the prism A. In in this way, the frictional force between the clamping arm 403 and the prism A is increased, and the clamping device 40 stably clamps the prism A; and further, the cushion member 405 may effectively protect the prism A, and the prism A is not easily scratched by the clamping arm 403, thereby effectively protecting the optical performance of the prism A.

Referring to FIG. 2, the controller 50 is connected to the manipulator 10, the first drive unit 20, and the second drive unit 30. In the case that the manipulator 10 includes a robot arm, the vacuum generator 102, and the vacuum cup 103, the controller 50 is specifically connected to the vacuum generator 102. In response to being specifically connected to the vacuum generator 102, the controller 50 is configured to control the vacuum generator 102 to operate such that the vacuum cup 103 suctions the prism A, and control the vacuum generator 102 to stop such that the vacuum cup 103 releases the suctioned prism A. The controller 50 is further configured to control the first drive unit 20 to drive the manipulator 10 to be lifted or lowered. The controller 50 is further configured to control the second drive unit 30 to drive the first drive unit 20 to reciprocate between the first station 10a and the second station 10b.

It should be noted that, program steps involved in the controller 50 may employ conventional program steps. The controller 50 may also employ a convention processor, for example, an Intel 13 processor, an AMD Ryzen processor, or the like.

In the embodiments of the present disclosure, a method for assembling the prism A to the fitting body B by the manipulator 10 is as follows: The controller 50 controls manipulator 10 to grasp the prism A positioned at the first station 10a, the first drive unit 20 drives the manipulator 10 to be lifted, and the second drive unit 30 drives the first drive unit 20 to move the prism A clamped in the manipulator 10 to the second station 10b. Specifically, the prism A is moved above the clamping device 40 disposed on the fitting body B placed on the second station 10b, the first drive unit 20 drives the prism A clamped in the manipulator 10 to be lowered, the prism A applies an action force against the carrier 401, the first elastic member 402 is compressed, the second elastic member 404 is compressed, the three clamping arms 403 move respectively towards a direction away from the carrier 401, in the case that the in-position detection unit detects that the carrier 401 moves to the predetermined position, the controller 50 controls the manipulator 10 to release the prism A clamped in the manipulator 10, the first elastic member 402 rebounds, the second elastic member 404 rebounds, the three clamping arms 403 move respectively towards a direction close to the carrier 401, and the prism A is clamped among the three clamping arms 403. The clamping arm 403 is bent towards the carrier 401 to form a hook 4031, the prism A is clamped in the three clamping arms 403, and three hooks 4031 formed via bending the three clamping arms 403.

In the embodiments of the present disclosure, the apparatus for assembling the prism A includes: the first station 10a, configured for placement of the prism A; the second station 10b, configured for placement of the fitting body B; the manipulator 10, configured to grasp the prism A; the first drive unit 20, connected to the manipulator 10, and configured to drive the manipulator 10 to be lifted or lowered; and the second drive unit 30, connected to the first drive unit 20, and configured to drive the first drive unit 20 to reciprocate between the first station 10a and the second station 10b; the clamping device 40, disposed in the mounting slot B1 of the fitting body, and configured to clamp the prism A; and the controller 50, connected to the manipulator 10, the first drive unit 20, and the second drive unit 30. The prism A is grasped by the manipulator 10, and the manipulator 10 moves the prism A to the fitting body B under the actions of the first drive unit 20 and the second drive unit 30 and releases the prism A, and the prism A is assembled to the clamping device 40 of the fitting body B. In this way, the manipulator 10 assembles the prism A to the fitting body B with no need of manual assembling of the prism A, and the operation is convenient.

An embodiment of the present disclosure further provides a production facility. The production facility includes the apparatus for assembling the prism A. For details of the specific structure and functionality of the apparatus for assembling the prism A, reference may be made to the above embodiment, which are not described herein any further.

It should be noted that the specification and drawings of the present disclosure illustrate preferred embodiments of the present disclosure. However, the present disclosure may be implemented in different manners, and is not limited to the embodiments described in the specification. The embodiments described are not intended to limit the present disclosure, but are directed to rendering a thorough and comprehensive understanding of the disclosure of the present disclosure. In addition, the above described technical features may incorporate and combine with each other to derive various embodiments not illustrated in the above specification, and such derived embodiments shall all be deemed as falling within the scope of the specification of the present disclosure. Further, a person skilled in the art may make improvements or variations according to the above description, and such improvements or variations shall all fall within the protection scope as defined by the claims of the present disclosure.

1. An apparatus for assembling a prism, configured to assemble the prism into a mounting slot of a fitting body, and comprising:
a first station, configured for placement of the prism;
a second station, configured for placement of the fitting body;
a manipulator, configured to grasp the prism;
a first drive unit, connected to the manipulator, and configured to drive the manipulator to be lifted or lowered;
a second drive unit, connected to the first drive unit, and configured to drive the first drive unit to reciprocate between the first station and the second station;
a clamping device, disposed in the mounting slot of the fitting body, and configured to clamp the prism; and
a controller, connected to the manipulator, the first drive unit, and the second drive unit.

2. The apparatus according to claim 1, wherein the clamping device comprises a carrier, a first elastic member, a clamping arm, and a second elastic member;
the first elastic member is disposed at a bottom of the mounting slot; an end, distal from the fitting body, of the first elastic member is connected to the carrier; an end, distal from the first elastic member, of the carrier is configured to carry the prism, and the carrier is movable relative to the fitting body;
the second elastic member is disposed on a wall of the mounting slot; an end, distal from the fitting body, of the second elastic member is connected to one end of the clamping arm; another end of the clamping arm is abutted against the carrier, and still another end of the clamping arm is configured to be abutted against the prism, and the clamping arm is movable relative to the fitting body; and
the first drive unit drives the manipulator to be lowered, the prism grasped by the manipulator applies an action force against the carrier, the first elastic member is compressed, the second elastic member is compressed, the clamping arm moves towards a direction away from the carrier, the manipulator releases the prism, the first elastic member rebounds, the second elastic member rebounds, the clamping arm moves towards a direction close to the carrier, and the prism is clamped between the clamping arm and the mounting slot.

3. The apparatus according to claim 2, wherein a distance from an end, distal from the bottom of the mounting slot, of the carrier to the bottom of the mounting slot is not less than a distance from the still another end of the clamping arm to the bottom of the mounting slot.

4. The apparatus according to claim 2, wherein three second elastic members are configured, three clamping arms are configured, the three second elastic members are distributed on the wall of the mounting slot; and an end, distal from the fitting body, of one of the second elastic members is connected to one end of one of the clamping arms.

5. The apparatus according to claim 2, wherein the still another end of the clamping arm is bent towards the carrier to form a hook, wherein the hook is configured to be fitted to an end, distal from the carrier, of the prism in response to the prism being carried by the carrier.

6. The apparatus according to claim 5, further comprising an in-position detection unit, wherein the in-position detection unit is disposed in the mounting slot and connected to the controller; and the controller controls, in response to detecting that the carrier moves to a predetermined position by the in-position detection unit, the manipulator to release the prism grasped by the manipulator, such that the hook is abutted against the end, distal from the carrier, of the prism.

7. The apparatus according to claim 2, wherein the carrier is provided with a first ramp, the first ramp being disposed to face the bottom of the mounting slot; and the another end of the clamping arm is provided with a second ramp, the second ramp being disposed to face the first ramp, and the second ramp being abutted against the first ramp.

8. The apparatus according to claim 2, wherein the clamping device further comprises a cushion member, wherein the cushion member is disposed at the still another end of the clamping arm, and configured to be abutted against the prism.

9. The apparatus according to claim 1, wherein
the manipulator comprises a connection arm, a vacuum generator, and a vacuum cup;
one end of the connection arm is connected to the first drive unit and the other end of the connection arm is connected to the vacuum generator, and the vacuum generator is further connected to the vacuum cup; and
the vacuum generator is further connected to the controller, and the controller is further configured to control the vacuum generator to operate such that the vacuum cup suctions the prism.

10. A production facility, comprising an apparatus for assembling a prism;
wherein the apparatus is configured to assemble the prism into a mounting slot of a fitting body, and comprises:
a first station, configured for placement of the prism;
a second station, configured for placement of the fitting body;
a manipulator, configured to grasp the prism;
a first drive unit, connected to the manipulator, and configured to drive the manipulator to be lifted or lowered;
a second drive unit, connected to the first drive unit, and configured to drive the first drive unit to reciprocate between the first station and the second station;
a clamping device, disposed in the mounting slot of the fitting body, and configured to clamp the prism; and
a controller, connected to the manipulator, the first drive unit, and the second drive unit.

11. The production facility according to claim 10, wherein the clamping device comprises a carrier, a first elastic member, a clamping arm, and a second elastic member;
the first elastic member is disposed at a bottom of the mounting slot; an end, distal from the fitting body, of the first elastic member is connected to the carrier; an end, distal from the first elastic member, of the carrier is configured to carry the prism, and the carrier is movable relative to the fitting body;
the second elastic member is disposed on a wall of the mounting slot; an end, distal from the fitting body, of the second elastic member is connected to one end of the clamping arm; another end of the clamping arm is abutted against the carrier, and still another end of the clamping arm is configured to be abutted against the prism, and the clamping arm is movable relative to the fitting body; and
the first drive unit drives the manipulator to be lowered, the prism grasped by the manipulator applies an action force against the carrier, the first elastic member is compressed, the second elastic member is compressed, the clamping arm moves towards a direction away from the carrier, the manipulator releases the prism, the first elastic member rebounds, the second elastic member rebounds, the clamping arm moves towards a direction close to the carrier, and the prism is clamped between the clamping arm and the mounting slot.

12. The production facility according to claim 11, wherein a distance from an end, distal from the bottom of the mounting slot, of the carrier to the bottom of the mounting slot is not less than a distance from the still another end of the clamping arm to the bottom of the mounting slot.

13. The production facility according to claim 11, wherein three second elastic members are configured, three clamping arms are configured, the three second elastic members are distributed on the wall of the mounting slot; and an end, distal from the fitting body, of one of the second elastic members is connected to one end of one of the clamping arms.

14. The production facility according to claim 11, wherein the still another end of the clamping arm is bent towards the carrier to form a hook, wherein the hook is configured to be fitted to an end, distal from the carrier, of the prism in response to the prism being carried by the carrier.

15. The production facility according to claim 14, further comprising an in-position detection unit, wherein the in-position detection unit is disposed in the mounting slot and connected to the controller; and the controller controls, in response to detecting that the carrier moves to a predetermined position by the in-position detection unit, the manipulator to release the prism grasped by the manipulator, such that the hook is abutted against the end, distal from the carrier, of the prism.

16. The production facility according to claim 11, wherein the carrier is provided with a first ramp, the first ramp being disposed to face the bottom of the mounting slot; and the another end of the clamping arm is provided with a second ramp, the second ramp being disposed to face the first ramp, and the second ramp being abutted against the first ramp.

17. The production facility according to claim 11, wherein the clamping device further comprises a cushion member, wherein the cushion member is disposed at the still another end of the clamping arm, and configured to be abutted against the prism.

18. The production facility according to claim 10, wherein
the manipulator comprises a connection arm, a vacuum generator, and a vacuum cup;
one end of the connection arm is connected to the first drive unit and the other end of the connection arm is connected to the vacuum generator, and the vacuum generator is further connected to the vacuum cup; and
the vacuum generator is further connected to the controller, and the controller is further configured to control the vacuum generator to operate such that the vacuum cup suctions the prism.

19. An apparatus for assembling a prism, configured to assemble the prism to a fitting body, and comprising:
a first station, configured for placement of the prism;
a second station, configured for placement of the fitting body;
a manipulator, configured to grasp the prism;
a first drive unit, connected to the manipulator, and configured to drive the manipulator to be lifted or lowered;
a second drive unit, connected to the first drive unit, and configured to drive the first drive unit to reciprocate between the first station and the second station; and
a clamping device, disposed on the fitting body, and configured to clamp the prism.

20. The apparatus according to claim 19, wherein the clamping device comprises a carrier, a first elastic member, a clamping arm, and a second elastic member;
the first elastic member is disposed on the fitting body; an end, distal from the fitting body, of the first elastic member is connected to the carrier; an end, distal from the first elastic member, of the carrier is configured to carry the prism, and the carrier is movable relative to the fitting body;
the second elastic member is disposed on the fitting body; an end, distal from the fitting body, of the second elastic member is connected to one end of the clamping arm;
another end of the clamping arm is abutted against the carrier, and still another end of the clamping arm is configured to be abutted against the prism, and the clamping arm is movable relative to the fitting body; and
the first drive unit drives the manipulator to be lowered, the prism grasped by the manipulator applies an action force against the carrier, the first elastic member is compressed, the second elastic member is compressed, the clamping arm moves towards a direction away from the carrier, the manipulator releases the prism, the first elastic member rebounds, the second elastic member rebounds, the clamping arm moves towards a direction close to the carrier, and the prism is clamped between the clamping arm and the fitting body.
